(19) United States
(12) Patent Application Publication
(10) Pub. No.: US 2020/0130559 A1
(43) Pub. Date: Apr. 30, 2020

(54) Mobile Fitness Center Platform

(71) Applicant: Matthew Calabria, Barnegat, NJ (US)

(72) Inventor: Matthew Calabria, Barnegat, NJ (US)

(21) Appl. No.: 16/364,133

(22) Filed: Mar. 25, 2019

Related U.S. Application Data
(60) Provisional application No. 62/750,247, filed on Oct. 24, 2018.

(51) Int. Cl. B60P 3/14; A63B 69/20; A63B 71/00; B62D 63/08; B62D 63/06; B60S 9/02; B60P 1/43; B62D 29/00

(52) U.S. Cl. CPC B60P 3/14; A63B 69/201; A63B 71/0036; B62D 63/08; B60H 1/00; B60S 9/02; B60P 1/435; B62D 29/00; A63B 2210/00; B62D 63/062

(57) ABSTRACT

Embodiments are provided for a mobile fitness center that is capable of attaching to a vehicle to provide an on-site fitness center that is capable of being used in urban environments and on the side of streets without disconnecting to a vehicle. In some embodiments the mobile fitness center has a wedge-shaped front end that provides for expanded room inside for workout activities. Further, in some embodiments the mobile fitness center includes a side door, allowing access to the mobile fitness center from the side of a busy street.

### CROSS-REFERENCE TO RELATED APPLICATIONS

This application claims priority to U.S. Provisional Application No. 62/750,247 filed Oct. 24, 2018, which is incorporated by reference in its entirety.

### FIELD OF THE DISCLOSURE

This disclosure relates generally to the field of mobile platforms for providing an on-site fitness center, and more particularly, a mobile platform capable of being connected and towed by a vehicle and providing a mobile fitness center on the side of a street.

### BACKGROUND

Personalized fitness classes to help people improve their physical well-being are becoming more popular in gyms and fitness centers. These personalized classes help individuals workout with a trainer that can help them reach their personal fitness goals and are tailored to the individual's body and goals rather than a broad workout plan that is for the masses that isn't as effective.

Thus, fitness enthusiasts value how important it is to have a workout that targets their areas of improvements and leverages their strengths. However, individual workouts, with and without a trainer, can be challenging due to busy schedules that often make it difficult to go a gym. Additionally, traveling to a gym requires a user to have commute, which can be difficult for some people, especially those living in urban environments that do not have a car.

There have been some attempts to solve the problems and difficulties of working out in a gym and having individual workout sessions. For example, U.S. Pat. No. 5,667,267 discloses a mobile fitness center that has training equipment such as weights and is in the form of a trailer with having a top, bottom, front, and back portions along with a pair of longitudinal sides.

U.S. Pat. No. 9,750,999 is another example of existing attempts to address the shortcomings of conventional gyms. This patent discloses a mobile fitness unit in a converted shipping container. The mobile fitness unit may be towed, or air lifted into position, and the sides can unfold to transform into fitness centers. The workout equipment includes lateral pull-down cables, punching-bags, and other apparatuses.

Although these patent application attempts to describe using various ways to provide a mobile fitness area to a user, these patents still include several disadvantages of the conventional gym and workout systems. More specifically, these patents fail to include an adequate mobile gym suitable for use on the side of a street and urban environments.

Due to all of the existing shortcoming in presently available devices, there is still a need for a mobile platform as described further below in the present description.

### SUMMARY

The disclosure presented herein relates to a mobile fitness center that attaches to a vehicle to provide an on-site fitness that center that is capable of being used in urban environments and on the side of streets without disconnecting to said vehicle. In one or more non-limiting examples, a platform supported by two or more wheels and a vehicle or stabilization bar as described in one or more embodiments herein may be used as a mobile fitness center for providing a providing a workout space. Those of ordinary skill will appreciate that other uses may be foreseeable also and are included within the scope of the present description.

In one aspect, one or more embodiments for providing a mobile fitness center are provided in the present description, whereby the mobile fitness center includes a platform, at least two wheels supporting said platform, two longitudinal sides having at least one door, a back end having a ramp, a wedge shaped front end, and a tow hitch. Further, the present mobile fitness center may comprise one or more stabilization bars to provide stabilization of the mobile fitness center when in use.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a view of an exemplary mobile fitness center according to various aspects of the present disclosure.

FIG. 2 is a view of an exemplary mobile fitness center according to various aspects of the present disclosure.

FIG. 3 is a rear view of the mobile fitness center shown in FIG. 2.

FIG. 4 is a right-side view of the mobile fitness center shown in FIG. 2.

FIG. 5 is a left-side view of the mobile fitness center shown in FIG. 2.

FIG. 6 is an interior view of the front end of said mobile fitness center as shown in FIG. 2.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description includes one or more embodiments for various mobile fitness centers that may be used to provide a workout space in urban environments or provide gym equipment on the side of a narrow street and provide workout space without increasing the width of said mobile fitness centers. In one or more embodiments, a mobile fitness center may include one or more methods for stabilizing said mobile fitness center and increasing the access or air flow into said mobile fitness center. For example, in one or more embodiments, various stabilization bars or methods may be utilized to stabilize the platform when the mobile fitness center is being used. The mobile fitness center, in one or more embodiments, may have a rear ramp that allow for easy entrance into the mobile fitness center as well as large amounts of air flow to provide for a better workout experience. Elements included herein are meant to be illustrative, rather than restrictive. Persons having ordinary skill in the art relevant to the present disclosure may understand there to be equivalent elements that may be substituted with the present disclosure without changing the essential function or operation of the mobile fitness center.

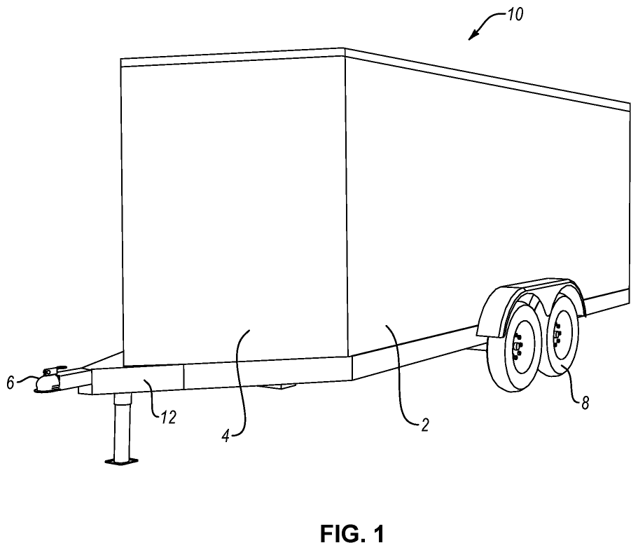

Turning to FIG. 1, a view of an exemplary mobile fitness center 10 according to various aspects of the present disclosure is shown. In one or more embodiments, the mobile fitness center 10 may be attached to a towing vehicle to provide a mobile fitness center to allow for a user to be able to work out in front of their residence or any covenant location without traveling to a gym. Further, the mobile fitness center 10, in one embodiment, provides a mobile fitness that is capable of being used while still attached to its towing vehicle, and does not require any further space, width wise or length wise, in order to be used. This makes the mobile fitness center 10 capable of being used as a workout space in urban environments or on the side of streets.

In the FIG. 1 view, the platform 12, the tow hitch 6, the wheels 8, the front end 4, and the side wall 2 are shown.

The platform 12 is the base structure of the mobile fitness center 10 upon which the entire mobile fitness center is built. The platform 12, in one embodiment, may have a truss frame and one or more axels supporting wheels 8 to allow towing of the mobile fitness center 10 to any on-site location. In another embodiment, the mobile fitness center 10 includes a floor built on top of or onto said truss frame. In a further embodiment, a plurality of beams is attached to the floor and a roof is supported by the plurality of beams.

Attached to the front end of the platform is the tow hitch 6. The tow hitch allows the mobile fitness center 10 to be able to attach to a towing vehicle, such as a truck, and be towed. The mobile fitness center is configured to be able to be used as a fitness center, in one embodiment, while still attached to a towing vehicle, via the tow hitch 6. This allows for the mobile fitness center to be more versatile, and up and running with minimum adjustments once the mobile fitness center 10 arrives to its site. In another embodiment, the mobile fitness center 10 can be detached from the towing vehicle before being used.

The front end 4 of the mobile fitness center 10 is also shown. In the FIG. 1 view, the front end 4 is wedge shaped, and is made out of two panels making the wedge shaped, appearing as a triangle as viewed from a top down view, from end 4.

Additionally, the side wall 2, and specifically the left side wall, of the mobile fitness center is shown in the FIG. 1 view. This side wall 2 is a longitudinal rectangular shape, and in the FIG. 1 embodiment, has a wheel well cut out for the wheels 8. As discussed below, the right side of the FIG. 1 embodiment has a similar shaped side wall as the left side, with a door attached. The side walls and the front end, in one embodiment, are made out of sheet metal. In one embodiment, the side walls 2 and front end 4 are made out of diamond plate, a type of metal stock with a regular pattern of raised diamonds or lines on one side, with the reverse side being featureless, and is made out of steel, stainless steel, or aluminum. In a further embodiment, the side walls and front end are made out of any material commonly used in to make the walls of trailers.

Also shown in the FIG. 1 embodiment are the wheels 8. In the FIG. 1 embodiment, the mobile fitness center 10 has two axels, with two wheels on both sides of the mobile fitness center. In another embodiment, the mobile fitness center has 1 or more axels, with two wheels per axel.

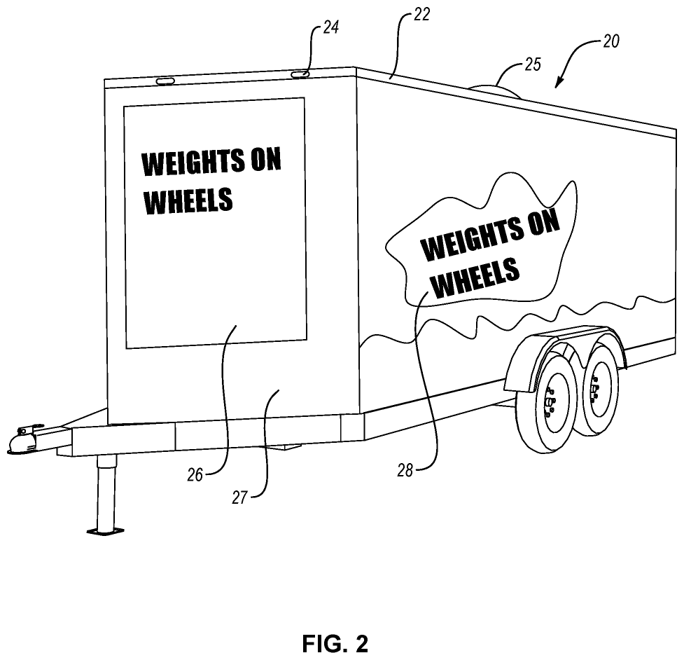

FIG. 2 is a view of an exemplary mobile fitness center 20 according to various aspects of the present disclosure. The FIG. 2 embodiment includes many elements not show in the FIG. 1 embodiment, including a top crowning 22, a roof fan or air conditioner 25, top lighting 24, front end advertising 26, side wall advertising 28, and a front-end damage protector 27.

In the FIG. 2 embodiment, the front-end damage protector can be a piece of metal, or other suitable material, that is attached to the lower end of the mobile fitness platform in order to protect it from rock damage, or any other material, that can be thrown from the tires of the towing vehicle during transport. This protects the remaining portions of the mobile fitness center 20 from receiving damage during transport.

On the top of the mobile fitness center 20, the top crowning around the top perimeter of the of the sides and front end is shown. This tow crowning can be used for cosmetic reasons to increase the visual appeal of the mobile fitness center, to aide in the attachment of the roof to rest of the mobile fitness center, and functionally as a placement for the top lighting 24. The top lighting can include braking lights, turn signals, as well as illuminating lighting for use in advertising the unit through lighting effects or providing a source of lighting around the unit at night time for night workouts.

Additionally, the FIG. 2 embodiment shows the roof fan 25. The roof fan can be installed to provide circulation inside of the mobile fitness center 25. In some embodiments, a roof air conditioner unit can be installed in addition to, or instead of, the roof fan. In a further embodiment, roof sun lights or vents can be installed to allow for natural lighting or air to enter into the mobile fitness center 20.

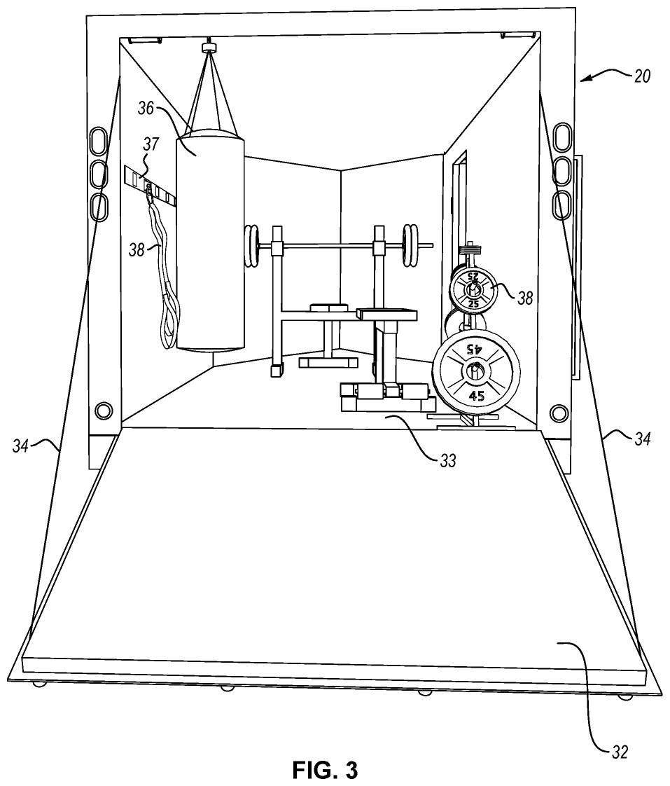

FIG. 3 is a rear view of the mobile fitness center shown in FIG. 1. As shown in this view, the mobile fitness center 20 also includes a back end comprising a boarding-ramp assembly attached to the platform of the mobile fitness center. The boarding-ramp assembly has at least one rotating panel 32 that is attached to an edge of the floor of the platform or frame at the back end of the mobile fitness center 20, said attachments is at a corresponding edge of said panel by a joint, or rotatable joint, having a degree of freedom, the rotating panel 32 configured to rotate between a first position perpendicular to the floor 33 and a second position whereby the rotating panel extends from the floor 33 to the ground. When in the first position, the rotating panel 32 is closed, and the mobile fitness center 20 can travel without any equipment inside falling out the back. When in the second position, the rotating panel 32 is down, creating a ramp. The ramp can be used for a user of the fitness center to easily access the inside of the mobile fitness center, and as a way to allow natural air flow throughout the unit. In one embodiment, the rotating panel 32 can be raised and lowered using the cords 34, which can be operated manual or with assistance of a motor.

In the FIG. 2 embodiment, the floor 33 is built on top of the frame of the mobile fitness center 32. The floor 33 can be made out of any materials commonly used in trailers and recreational vehicles. In some embodiments, the floor includes a top layer gym flooring, similar to gym flooring commonly found in use with gym weights.

Also show in FIG. 2 is some of the workout, gym equipment, or other fixtures that can located inside of the mobile fitness center 20. This includes attached ropes 37, punching bags 36 attached to the ceiling or sides of the unit, weight racks 38 attached to the floor or sides of the unit to prevent dumbbells or other weights shifting during transportation, interior lighting, bench press racks that can be secured to the interior sides or floor during transportation, benches that are secured to the floor, and weights that can be secured to weight racks for transportation. The side walls of the mobile fitness center 20 can also include attachment points 37 that allow for that attachment of ropes, elastic bands or other exercise equipment. The attachment points 37 can include hooks or any other means capable of attaching workout equipment to the side walls.

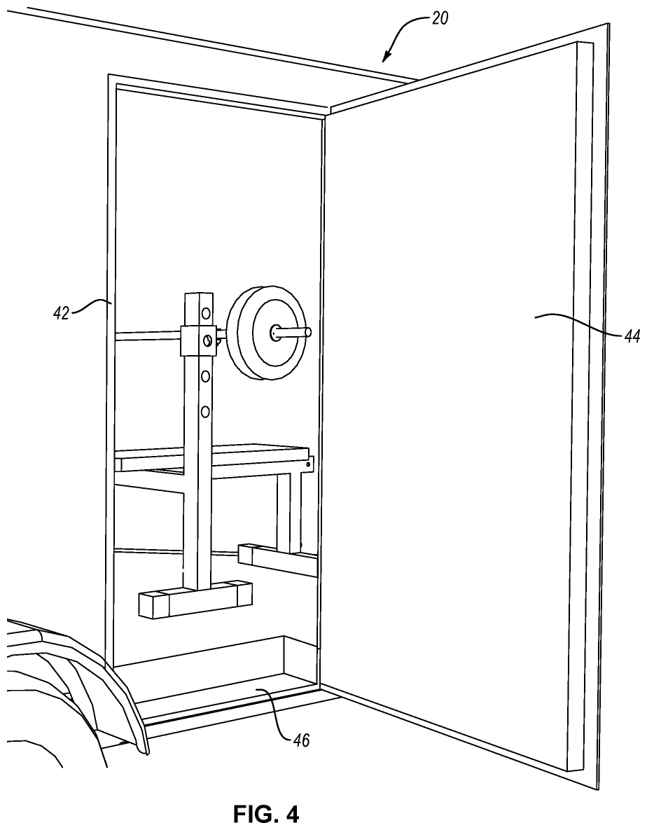

FIG. 4 is a right-side view of the mobile fitness center shown in FIG. 2. This view shows that the mobile fitness center 20 can include a door 44 located on the side of the mobile fitness center. In the FIG. 4 view, the door 44 is located on the right side, but in other embodiments the door can be located on the left side. A door frame 42 in located on one of the elongated sides of the mobile fitness center, and a door 44 is attached to one side of said door frame to allow for easy access into the mobile fitness center. In some embodiments, the mobile fitness center can also include a step 46 to allow for easy access into the mobile fitness center. By having a ramp entrance in the rear of the mobile fitness center, and a door entrance on the side, the mobile fitness center can be used only narrow streets to allow entrance from two different sides.

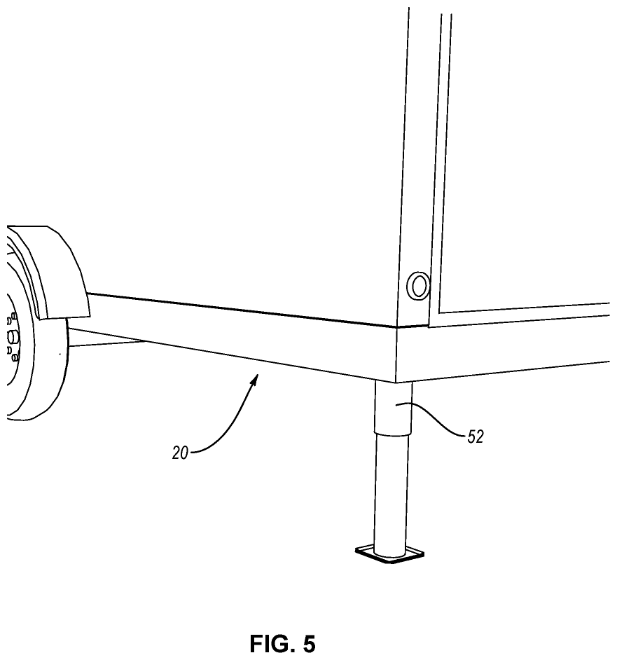

FIG. 5 is a left-side view of the mobile fitness center shown in FIG. 2. This view shows that the mobile fitness center can be equipped with a stabilization bar 52. The stabilization bar can be used to stabilize the mobile fitness center and prevent it from moving while be used for a workout by a user. The stabilization bar, as shown in the FIG. 5 view, can be located on the back of the mobile fitness center and extend down, and lock into place when it is touching the ground. This will prevent the back end of the mobile fitness center from being able to move during a workout, and when heavy weights are being used inside, because the stabilization bar supports the mobile fitness center. In other embodiments, two or more stabilization bars can be located on the mobile fitness center, and they can be located on any side.

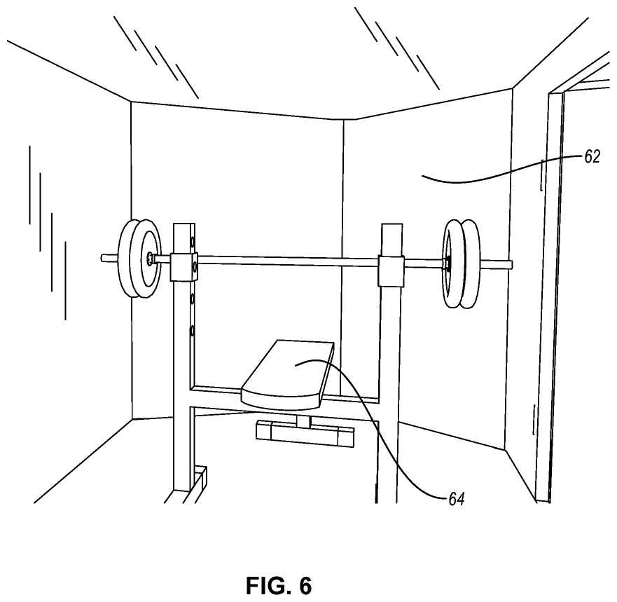

FIG. 6 is an interior view of the front end of said mobile fitness center as shown in FIG. 1. This view shows how the front end, which is comprised of two panels, forms the interior wedge shape 62. The interior wedge shape 62 is advantageous as it provides extra interior space over a box design. Additionally, the interior wedge shape is uniquely suited for placement of a bench 64 to be used for exercises, such as the bench press, due to its elongated shape. This allows for the bench to be placed inside of the interior wedge shape 62, at the front end of the mobile fitness center, without taking up too much space and allowing for more exercise equipment to be included.

It is noted that any of the securing devices shown in FIGS. 1-6 may be formed from any suitable material, even if the cross-hatching used in any of these Figures may be illustrative of a material.

Advantageously, the present description provides one or more embodiments of various types of mobile fitness centers. Each mobile fitness center depicted herein provides advantages that overcome shortcomings of other types of fitness centers (ex. brick and mortar gyms) that are used conventionally. Further, the various embodiments shown in the Figures and described herein accommodate different sized mobile fitness centers (including single or multiple axel mobile fitness centers) and may be used in various applications, including, but not limited, to providing an on-site mobile fitness center. It is noted that the various embodiments of mobile fitness centers presented herein may be used in many other ways other than to provide an on-site fitness center. For example, the various mobile fitness centers can be used to provide transportation of gym equipment or provide for a soldier training facility. Thus, the various embodiments described in the present description include a number of novel and helpful components that provide enhanced securing devices to benefit a user.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A mobile fitness center, comprising:
a platform;
at least two wheels supporting said platform;
two longitudinal sides comprising at least one door located on at least one of said two longitudinal sides;
a back end comprising a boarding-ramp assembly attached to said platform comprising at least one rotatable panel rotatable to a first and second position, wherein in said first position said rotatable panel is closed and in said second position said foldable panel is open;
a tow hitch located on said platform configured to attach to a vehicle;
at least one stabilization bar; and
a front end comprising at least two panels configured to form a wedge shape.

2. The mobile fitness center of claim 1, further comprising a floor located on top of said platform.

3. The mobile fitness center of claim 2, wherein said floor is defined by said two longitudinal side walls, said front end's two panels configured to form a wedge shape, and said back end attachment point to said at least one rotatable panel.

4. The mobile fitness center of claim 3, wherein a bench is attached to said floor on the area of the floor that is defined by said front end's two panels configured to form a wedge shape.

5. The mobile fitness center of claim 1, wherein the boarding-ramp assembly is attached to the edge of the platform at a corresponding edge of said panel by a rotatable joint.

6. The mobile fitness center of claim 1, further comprising one or more attachment points located on the longitudinal side walls, wherein said one or more attachment points are capable of connecting ropes or elastic bands.

7. The mobile fitness center of claim 1, further comprising a top crowning around the top exterior of said mobile fitness center.

8. The mobile fitness center of claim 1, wherein said two longitudinal sides are made of sheet metal.

9. The mobile fitness center of claim 1, further comprising a roof fan or air conditioner.

10. The mobile fitness center of claim 1, further comprising a step connected to said platform.

11. The mobile fitness center of claim 1, further comprising a stabilization bar located near the back end of said platform.

12. The mobile fitness center of claim 1, further comprising a weight rack mounted to a floor located on said platform.

13. The mobile fitness center of claim 1, further comprising a ceiling.

14. The mobile fitness center of claim 13, wherein a punching bag is attached to said ceiling.

15. The mobile fitness center of claim 14, wherein said ceiling further comprises an air vent.

16. The mobile fitness center of claim 1, further comprising a mobile air vent located on at least one of said two longitudinal sides.

17. A mobile fitness center, comprising:
an elongated workout room having five sides, a ceiling and a floor, wherein two of said five sides form a wedge-shaped front end, a back end further comprising one of said sides forming a rotatable ramp attached at one end to said floor, said ramp is configured to move from a first open position to a closed second position; and
a trailer comprised of a frame having five sides, four wheels and a tow hatch;
wherein, said elongated workout room is connected to said trailer.

18. The mobile fitness center of claim 17, wherein two of the five sides of said trailer form a wedge-shaped front end.

19. The mobile fitness center of claim 18, wherein said wedge-shaped front end of said elongated workout room is attached so said wedge-shaped front end of said trailer.

20. The mobile fitness center of claim 19, further comprising a side door located on said elongated workout room.
